(19) United States
(12) Patent Application Publication
(10) Pub. No.: US 2003/0130997 A1
(43) Pub. Date: Jul. 10, 2003

(54) Method of keyword-based searching for a similar case study

(76) Inventors: Patric Enewoldsen, Burscheid (DE); Bernhard Alzer, Koln (DE); Klaus Zander, Mulheim (DE)

Correspondence Address: BAYER POLYMERS LLC, 100 BAYER ROAD, PITTSBURGH, PA, 15205, US

(21) Appl. No.: 10/337,048

(22) Filed: Jan. 6, 2003

(30) Foreign Application Priority Data
Jan. 10, 2002 (DE) 10200604.0

(51) Int. Cl. G06F 7/00

(52) U.S. Cl. 707/3

(57) ABSTRACT

The present invention provides a method of searching for and locating a similar case study from a set of case studies (Fᵢ), wherein case study keywords are assigned to each case study, the method involving accepting an input search query containing one or more search keywords (Sⱼ), determining the most similar case study to each search keyword by a) calculating the distance from the search keyword to each case study keyword, b) establishing a minimum (Dⱼ) of the distance, c) repeating steps a) and b) for each search keyword, d) summing the minima for each case study, e) sorting the summed minima by size, and outputting the case study with the smallest summed minima. The method of the present invention is particularly well suited for implementation in a computer and/or computer system.

### FIELD OF THE INVENTION

The present invention relates to a method of searching for a similar case study from a set of case studies. The method is particularly well sutied for implementation in a computer and/or a computer system, such as a client-server computer system.

### BACKGROUND OF THE INVENTION

As those skilled in the art are aware, a rapidly expanding commercial sector is the offer, tender and sale of products and/or services by electronic means, such as over the Internet. This includes both offers intended for the end-user, the so-called “business to consumer” sector, and to trade between institutions, the so-called “business to business” sector.

Banks, retailers of consumer goods, telecommunications and electronics companies and the automotive industry, for example, use the Internet for so-called “E-business” platforms or portals to offer their products and/or services.

Such E-business platforms already play an especially important role in the chemical industry, because extensive automation of the goods delivery chain leads to significant cost reductions. In this context, a distinction should be made between company portals (for example KU Portal, BayerONE), marketplaces (for example Omnexus) and purchasing platforms (for example Covisint). Other examples of such E-business platforms are CC-MARKETS and “Elemica” which is a collaboration by twenty-two of the largest chemical companies in the world. Basic, special and fine chemicals can be ordered through Elemica.

Such a marketplace is particularly advantageous in the chemical industry in both the exchange of goods between chemical companies and in selling to buyers outside the chemical industry. An appropriate range of functions should provide a catalog of products, as well as functions for concluding contracts and for requesting the arranged delivery at the appropriate time. In addition, transport planning and storage may simultaneously be controlled electronically. Such functions are of great importance in the chemical trade.

However, known E-business platforms are disadvantageous, particularly for consultation-intensive products, because it is very difficult for a potential customer to select the most suitable ordering option for his or her purpose out of those available. This problem can arise, for example, when selecting polymers for customer-specific applications.

Therefore, a need exists in the art for a method of providing a potential customer with the opportunity of obtaining such goal-oriented information interactively, via the Internet, thereby enabling the customer to make an optimum selection of a case study regarding, for example, a polymer for his or her purpose.

### SUMMARY OF THE INVENTION

The present invention, therefore, greatly reduces or eliminates problems inherent in the art by providing a method for keyword-based searching for case studies. The method of the present invention may preferably be embodied in a computer program and/or computer system.

The present invention provides a method of searching for and locating a similar case study from a set of case studies (Fᵢ), wherein case study keywords are assigned to each case study, the method involving accepting an input search query containing one or more search keywords (Sⱼ), determining the most similar case study to each search keyword by a) calculating the distance from the search keyword to each case study keyword, b) establishing a minimum (Dⱼ) of the distance, c) repeating steps a) and b) for each search keyword, d) summing the minima for each case study, e) sorting the summed minima by size, and outputting the case study with the smallest summed minima.

### BRIEF DESCRIPTION OF THE FIGURES

The present invention will now be described for purposes of illustration and not limitation in conjunction with the Figures wherein:

FIG. 1 depicts a block diagram of one embodiment of a computer system according to the present invention;

FIG. 2 depicts one embodiment of a tree structure with a plurality of trees;

FIG. 3 depicts a flow chart of one embodiment of the method according to the present invention for searching for similar case studies;

FIG. 4 depicts a flow chart of the search for case studies similar to a previously selected case study;

FIG. 5 illustrates an input window for inputting a search query from a client computer;

FIG. 6 shows the output of similar case studies, which are sorted by relevance;

FIG. 7 illustrates an output window for displaying a case study; and

FIG. 8 shows an output of similar case studies found for the displayed case study of FIG. 7.

### DETAILED DESCRIPTION OF THE INVENTION

The present invention, which will now be described for purposes of illustration and not limitation, provides a method of searching for and locating a similar case study from a set of case studies (Fᵢ), wherein case study keywords are assigned to each case study, the method involving accepting an input search query containing one or more search keywords (Sⱼ), determining the most similar case study to each search keyword by a) calculating the distance from the search keyword to each case study keyword, b) establishing a minimum (Dⱼ) of the distance, c) repeating steps a) and b) for each search keyword, d) summing the minima for each case study, e) sorting the summed minima by size, and outputting the case study with the smallest summed minima.

The present invention further provides a method of searching for and locating one or more similar case studies from a set of case studies (Fᵢ), wherein case study keywords are assigned to each case study, the method involving accepting an input search query containing one or more search keywords (Sⱼ), determining the most similar case study to each search keyword by a) calculating the distance from the search keyword to each case study keyword, b) establishing a minimum (Dⱼ) of the distance, c) repeating steps a) and b) for each search keyword, d) summing the minima for each case study, e) sorting the summed minima by size, and outputing the case studies in the form of a list sorted by size of summed minima.

The present invention allows the user to formulate a search query with one or more search keywords selected from a predetermined union set of keywords to locate one or more case studies which are as similar as possible to the search query. Such a case study may contain, for example, a file with a picture of a similar product, as well as product information relating to a polymer used for producing that product and the production technology. The file may also contain other application-specific, technical and/or commercial information.

According to one embodiment of the present invention, the search for a similar case study, which corresponds as closely as possible to the search query, is carried out by calculating distances between data organized in a tree structure. The case studies are sorted by the sum of the minimum distances to the search keywords, and are output in this form for selection by the user.

According to a variation of the above-described embodiment of the present invention, the distances may be calculated by taking into account weightings of the branches of the tree structure.

According to another variation, the tree structure comprises a plurality of trees, with each tree belonging to a particular category, for example “technologies and processing”, “sectors”, “properties” and “products”.

According to another embodiment of the present invention, it is possible to have similar case studies determined automatically for a particular selected case study. This is done by rigidly assigning search keywords to each of the case studies. The set of search keywords assigned to a case study may be identical to the case study keywords. To search for case studies similar to the selected case study, the search keywords rigidly assigned to the selected case study are used as a search query.

According to yet another embodiment of the present invention, a computer system in a client-server architecture may be utilized, so that search queries from the client computer may be input over the Internet into the server computer where the search query is executed.

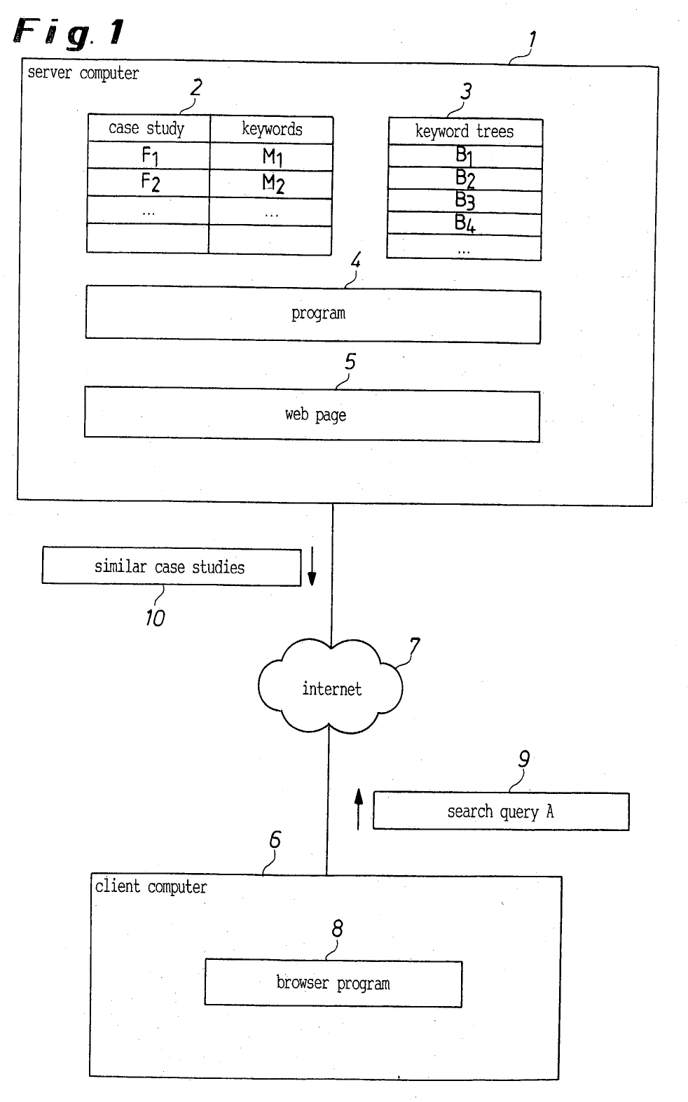

FIG. 1 shows a block diagram of a computer system according to the present invention with a client-server architecture. The computer system has a server computer 1 with a database 2 for storing case study files F₁, F₂, F₃, . . . . A set of case study keywords M₁, M₂, M₃, . . . may preferably be assigned to each of the case, study files.

The server computer 1 preferably has a database 3 for storing data preferably organized into a tree structure. In the embodiment of FIG. 1, the tree structure has a plurality of case study keyword trees B₁, B₂, B₃, B₄ . . . . Each of those keyword trees is assigned to a particular category, for example “technologies and processing”, “sectors”, “properties” and “products”.

As an example, the keyword tree B₁ may preferably be assigned to the category “technologies and processing”, and contain keywords from this subject area such as “sprue-gate technology”, “film in-mould decoration”, “moulded articles”, “gas injection technology (GIT)”, “multicomponent injection moulding”, “textile in-mould decoration”, “tool temperature control”, “extrusion blow moulding”, “film extrusion”, “solid sheet extrusion”, “profile extrusion”, “multiwall sheet extrusion”, “3D MID”, “thin-wall technology”, “hybrid technology”, “prototyping”, “heated-tool welding”, “laser welding”, “ultrasonic welding” and “vibration welding”.

In like manner, the keyword tree B₂ may preferably be assigned to the category “sectors”, and may contain such keywords as: “building”, “healthcare”, “IT”, “electrical”, “electronics”, “gardening”, “home”, “household”, “motor industry”, “machinery/plant”, “medicine”, “furniture”, “optical applications”, “sport/leisure” and “packaging”.

Likewise, the keyword tree B₃ may preferably be assigned to the category “properties”, and may contain such keywords as: “abrasion resistance”, “chemical stability”, “chemical”, “electrical”, “electrical properties”, “energy consumption”, “flameproofing”, “flexibility”, “scratch resistance”, “linear expansion”, “dimensional conformity”, “mechanical”, “long-term mechanical properties”, “surface”, “surface coating”, “surface technology”, “shrinkage”, “stiffness”, “thermal”, “transparency”, “retardation”, “weatherproofing”, “thermal deformation resistance” and “toughness”.

The keyword tree B₄ may preferably be assigned to the category “products”, and may contain the following keywords: “Apec”, “PC HAT”, “Bayblend”, “PC+ABS”, “Desmopan”, “TPU”, “Durethan A”, “PA 66”, “Novodur Lustran”, “ABS”, “Pocan”, “PBT”, “SAN”, “Triax” and “ABS+PA”.

Preferably, each of the case study keyword trees B₁, B₂, B₃, B₄ . . . may be a hierarchical tree, with a keyword being assigned to each node in a keyword tree. The keywords of the various keyword trees form disjoint sets of keywords. The case study keywords, which are assigned to the case study files, belong to the union set of disjoint sets. The selection of search keywords for a search query may preferably be made from this union set.

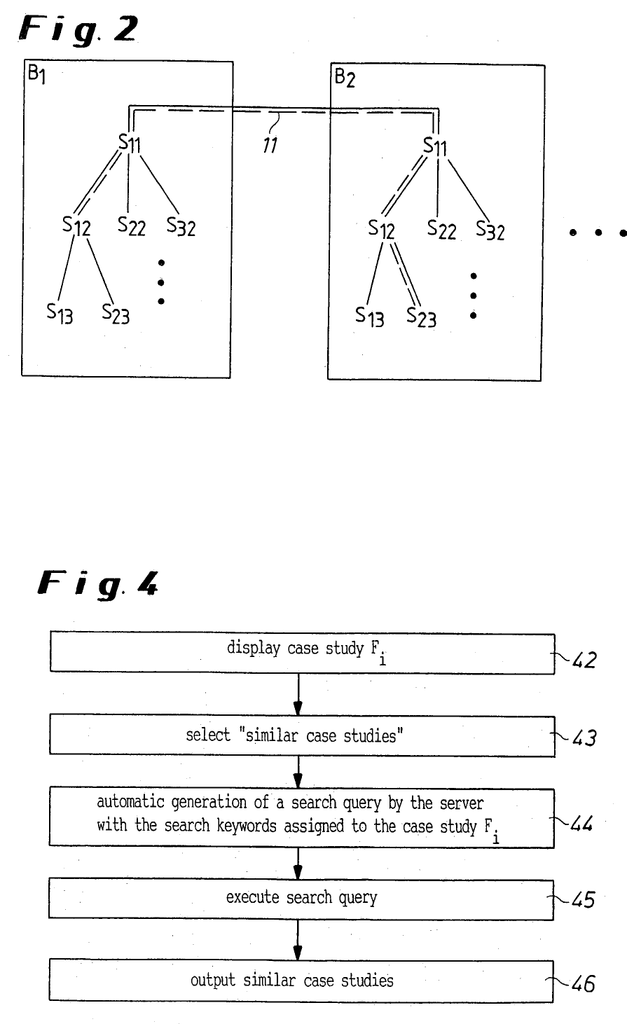

FIG. 2 depicts an exemplary embodiment of the hierarchical tree structure, based on keyword trees with weighted branches, and will be explained in more detail herein below.

A server computer 1 has a web page 5, such as an E-business platform. An input window is provided on this web page 5 to permit a user to input a search query.

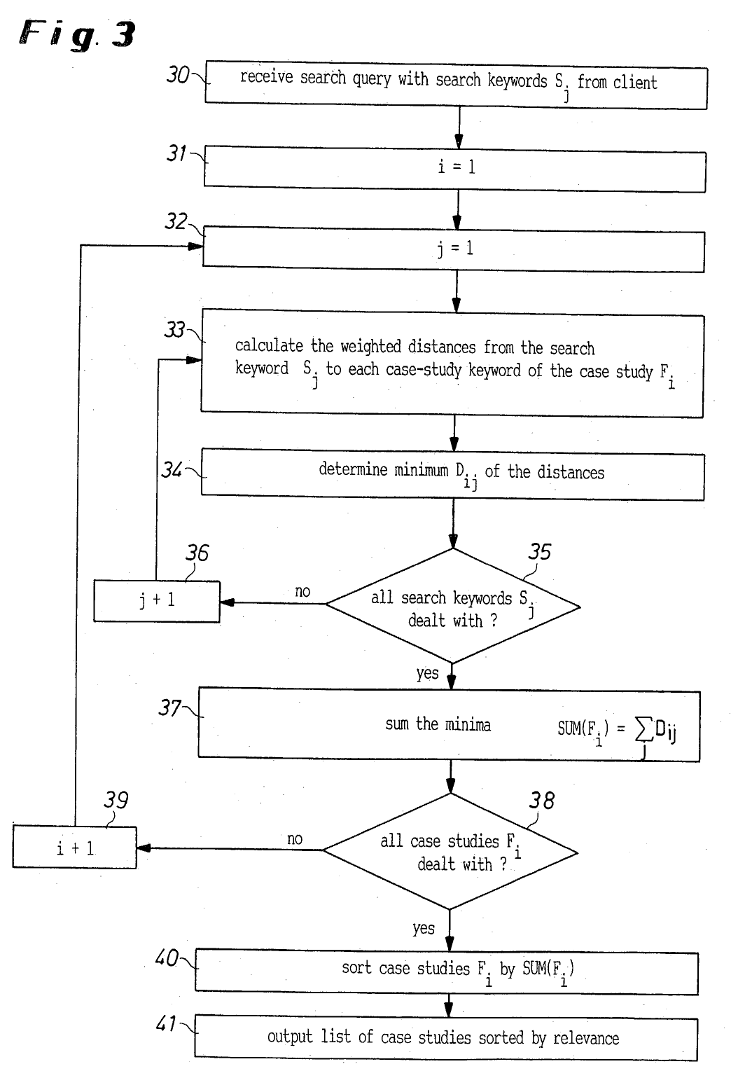

The server computer 1 also has a program 4, into which the search query with the search keyword(s) is input. This program 4 accesses the database 2 and the database 3, to determine one or more similar case studies and to generate a corresponding output screen. The nature of that calculation will be explained in more detail below with reference to FIG. 3.

The web page 5 of the server computer 1 can preferably be accessed from a client computer 6 via a computer network, such as the Internet 7. The client computer 6 preferably displays the web page 5 by means of its browser program 8, thereby providing the user of the client computer 6 with a graphical user interface through which the user can formulate his or her search query by selecting one or more search keywords from the union set of keywords.

After such a search query A has been input, a file 9 with the search keyword(s) is sent via the Internet 7 to the web page 5 from where the input into the program 4 takes place. The similar case study or case studies determined by the program 4 is/are sent in the form of a file 10 to the client computer 6 for display by the browser program 8.

FIG. 2 shows an embodiment of the present invention wherein the data is organized into a tree structure. The tree structure contains the case study keyword trees B₁, B₂, B₃ and B₄. For the sake of clarity, only one-half of the keyword trees B₁ and B₂ are represented in FIG. 2.

The keyword tree B₁ may preferably be assigned to the category “technologies and processing”. The keywords of the keyword tree B₁ may preferably be structured hierarchically, with the root S₁₁ of the keyword tree B₁ denoting the category, which is followed by various process categories, or special forms of the different process categories, in one or more subordinate hierarchy levels. For example, the nodes of the keyword tree B₁ of the second hierarchy level, i.e., the nodes S_{1 2}, S_{2 2}, S_{3 2}, are respectively assigned to the subcategories “injection molding”, “extrusion” and “bonding technologies”.

The following hierarchy level contains the respective special categories. Concerning the node S_{1 2} (“injection molding”), these are the special categories “standard injection molding” (S_{1 3}) and “special injection molding methods” (S_{2 3}). From the node “special injection molding methods” (S_{2 3}), further branches may lead off relating to the use of additional media (e.g., gas injection technology, water injection technology) and relating to multicomponent injection molding, in particular multicolor injection molding, hard/soft technologies and insert technologies (e.g., insert, outsert, hybrid, film in-mold decoration).

The individual branches in the resulting keyword tree B₁ may preferably be provided with a weighting, for example, between 0 and 2.0. The higher the weighting, the higher the degree of dissimilarity of the nodes connected by the branch.

Regarding the “sectors”, the keyword tree B₂ may preferably be correspondingly divided up hierarchically into main sectors, sub-sectors and special sectors. The same is true for the other keyword trees B₃ and B₄ as well.

These keyword trees may also preferably have weightings between 0 and 2.0 assigned to their branches. The roots of the individual keyword trees may also be connected to one another by branches, so as to provide a coherent tree structure.

FIG. 3 shows an embodiment of the method according to the present invention for searching for similar case studies. In step 30, a connection is set up between a client computer and a server computer. In the client computer, a search query containing one or more search keywords S₁, S₂, . . . Sⱼ, . . . is input by the user. The search keywords are elements of the union set of keywords of the tree structure (See FIG. 2).

For example, the search keyword S₁ may be the keyword assigned to the node S_{2 3} of the tree B₂. The search keyword S₂ may be the keyword assigned to the node S_{2 2} of the tree B₁, etc. The search keywords of the search query may belong to the same tree or to different trees of the tree structure.

In step 31, the index i=1 is set. In step 32, the index j=1 is set.

In step 33, the weighted distances from the search keyword S₁ to each case-study keyword of the example case F₁ are calculated. For example, the set M₁ of case-study keywords assigned to the case study F₁ (cf. database 2 of FIG. 1) contains the keywords S_{1 2} and S_{2 3} from the tree B₁ and the keyword S_{3 2} from the tree B₂.

In step 33, the weighted distance from the search keyword S₁, i.e., from the node S_{2 3} in the tree B₂, to the node S_{1 2} in the tree B₁, as well as the distances to the node S_{2 3} in the tree B₁ and to the node S_{3 2} in the tree B₂, are calculated. This is done by searching for a shortest path from the node of the search keyword S₁, i.e., from the node S_{2 3} in the tree B₂, to the node of the first case-study keyword, i.e., to the node S_{1 2} in the tree B₁. For the search for such a shortest path, it is possible to employ graph-theory methods, such as are known in the art.

In FIG. 2, the shortest path 11 between the search keyword node S_{2 3} in the tree B₂ and the case-study keyword node S_{1 2} in the tree B₁ is indicated by a dashed line. The path 11 contains the branches between the nodes S₂₃ and S₁₂, S₁₂ and S₁₁ in the tree B₂, the branch between the nodes S₁₁ of the tree B₂ and S₁₁ of the tree B₁, as well as the branch between the nodes S₁₁ and S₁₂ in the tree B₁.

From the path 11, the distance can be determined by adding up the number of branches contained in the path 11, which gives the distance of 4 in this example. Preferably, however, the distance is determined as a weighted distance. To that end, a weighting, G, may be assigned to each branch in the tree structure.

A branch may preferably be established by the nodes at its two ends. The weighting G may be selected so that it serves to express the similarity or dissimilarity of the keywords assigned to the two end nodes of the branch.

For example, the weighting G may preferably be selected from the value range between 0 and 2, a weighting of G=0 signifying quasi-identity and a weighting of G=2 signifying maximum variation.

The weightings of the branches of the path 11 may preferably be as follows: weighting of the branch between the nodes S₂₃ and S₁₂ of the tree B₂=0.1; weighting of the branch between the nodes S₁₂ and S₁₁ of the tree B₂ equal to 0.5; weighting of the branch between the nodes S₁₁ of the tree B₂ and S₁₁ of the tree B₁=2; weighting of the branch between the nodes S₁₁ and S₁₂ of the tree B₁=1.5.

Therefore, the sum of the weighted distances of the path 11 would be 4.1.

The weighted distances between the node S₂₃ and the other nodes of the set M₁, i.e., the node S₂₃ of the tree B₁ and the node S₂₃ of the tree B₂, may preferably be determined in like manner.

In step 34, the minimum of the distances established in step 33 is determined. This corresponds to the—taking the weightings into account—shortest path between the search keyword S₁, or the node S_{2 3} assigned to this search keyword in the tree B₂, and one of the nodes of the set M₁.

In step 35, a check is made as to whether all search keywords of the search query have already been dealt with. If not, the index j is incremented in step 36.

Thereupon, in step 33, the weighted distances from the search keyword S₂, i.e., from the corresponding node S₂₂ in the tree B₁, to the nodes of the set M₁ are calculated. In step 34, the minimum D₁₂ of the distances established in step 33 for i=1 and j=2 is determined. Thereupon, step 35 is carried out again and, where appropriate, the index j is incremented again in step 36, etc. This “loop” is run through for the case study F₁ and its set M₁ until a minimum distance D₁ⱼ to one of the case-study key words of the example case F₁ has been determined for all search keywords Sⱼ.

The minimum distances determined for a particular example case Fᵢ are added up in step 37 after the “loop” has been completed, which gives the value SUM (Fᵢ). Then, in step 38, a check is made as to whether all available case studies Fᵢ have already been dealt with, that is to say, all the case studies contained in the database 2 (cf. FIG. 1). If not, the index i is incremented in step 39 and the index j is reset to 1 in step 32. Thereupon, “the loop” is run through again to calculate the minimum distances relating to the next case study.

If it is found in step 38 that all available case studies Fᵢ have already been dealt with, then the case studies Fᵢ are sorted by their relevance in step 40, SUM (Fᵢ) being used as a sorting criterion. The smaller the value of SUM (Fᵢ) is, the more similar a case Fᵢ is to the profile specified in the search query.

In step 41, the case study is output in the form of a list sorted by relevance.

FIG. 4 shows how a user can proceed with this list.

In step 42, the user selects one of the case studies Fᵢ from the list, to have the content of the corresponding case-study file displayed. The display of the case-study file contains a virtual control element for calling up “similar case studies”.

In step 43, the user activates this control element. Thereupon, in step 44, a search query is automatically generated by the server computer. To that end, the server computer uses the search keywords assigned to the case study Fᵢ. These may be identical to the set Mᵢ (cf. database 2 of FIG. 1).

In step 45, the search query automatically generated in this way is dealt with according to the method of FIG. 3. The results of the search for similar case studies are output in step 46.

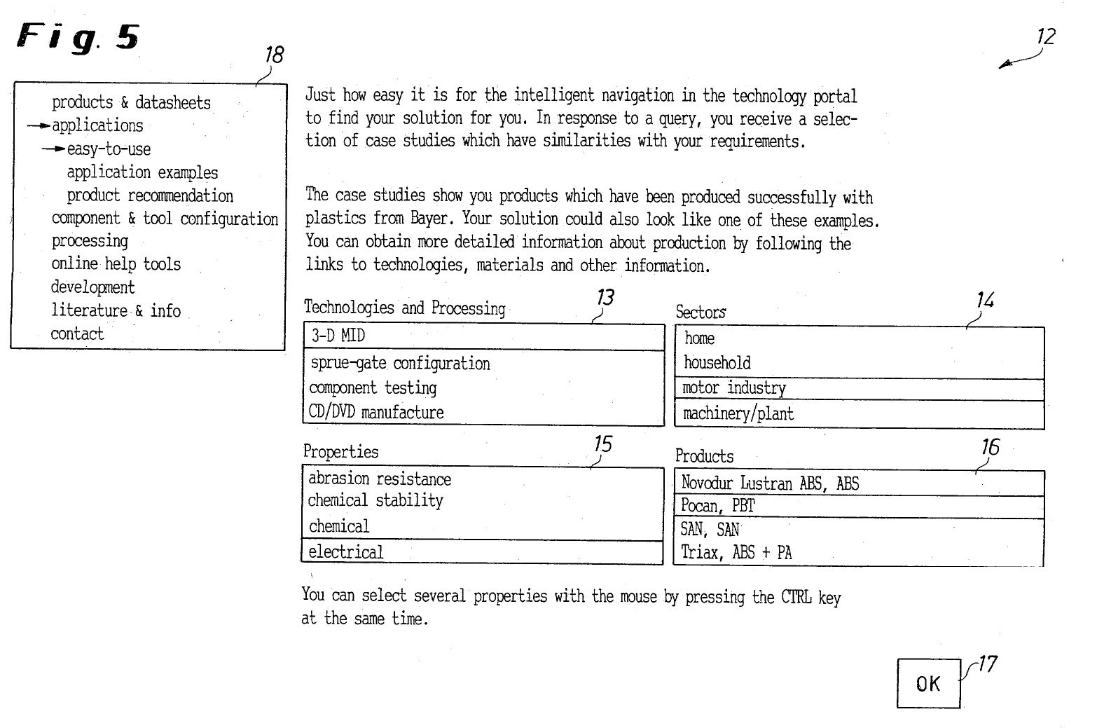

FIG. 5 shows an input window 12 of the web page 5 (cf. FIG. 1). The input window 12 contains the selection lists 13, 14, 15 and 16. The selection list 13 preferably contains keywords for the category “technologies and processing”, for example, “3D MID”, “sprue-gate configuration”, “component testing”, “CD/DVD manufacture”. These keywords are elements of the tree B₁ (cf. FIG. 2), which is assigned to the category “technologies and processing”. The selection list 13 may contain all the keywords of the tree B or a subset thereof.

The selection list 14 preferably belongs to the category “sectors”, and contains corresponding keywords which are elements of the tree B₂, such as “home”, “household”, “motor industry”, “machinery/plant”, . . . . A corresponding situation exists for the selection lists 15 and 16, which are assigned to the categories “properties” and “products” respectively.

To input a search query, the user selects one or more keywords from one, several or all of the selection lists 13, 14, 15 and 16. By activating the virtual control element 17 “OK”, the corresponding search query is sent from the user's client computer to the server computer, so that the program 4 is started there (cf. FIG. 1) to find case studies which are as similar as possible to the profile defined by the search query.

The user also has the opportunity to access other functions and information sources by means of the selection range 18. This involves direct access to product information and datasheets, technical information about component and tool design, processing and development.

So-called “online help tools” are also offered, which are computer programs for delivering data of relevance to the customer's design. This may, for example, involve determining properties of the desired plastic and/or the production conditions needed for manufacturing the plastic.

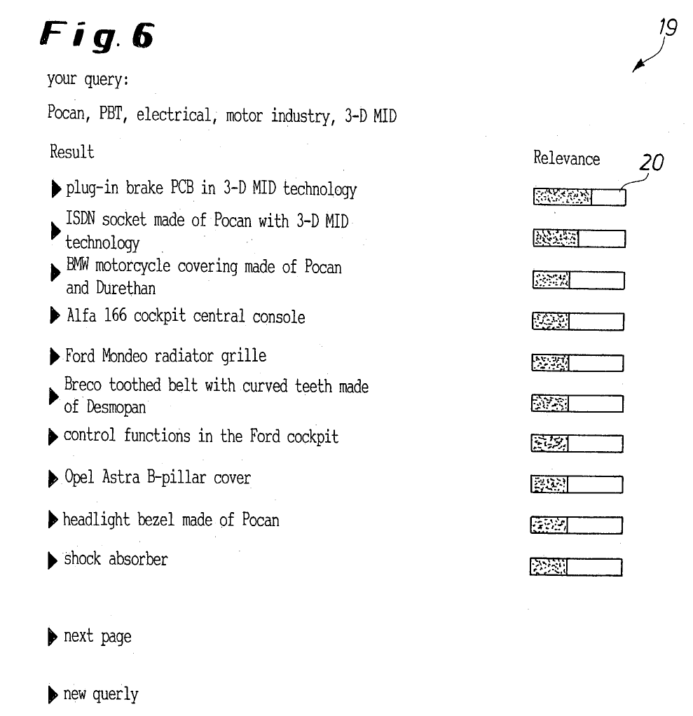

FIG. 6 shows an output window 19 which was generated by the program 4 for the search query with the search keywords “Pocan”, “PBT”, “electrical”, “motor industry”, “3D MID” (cf. FIG. 1). The result is a list of case studies, which may preferably be sorted by their relevance from top to bottom in decreasing order. The relevance of a case study is in each case graphically output by an indicator 20, the status of the indicator 20 being proportional to the value SUM (Fᵢ) (cf. step 37 and step 40 of FIG. 3).

In the output window 19, the case study “plug-in brake PCB in 3-D MID technology” has the highest relevance, and it is therefore positioned first.

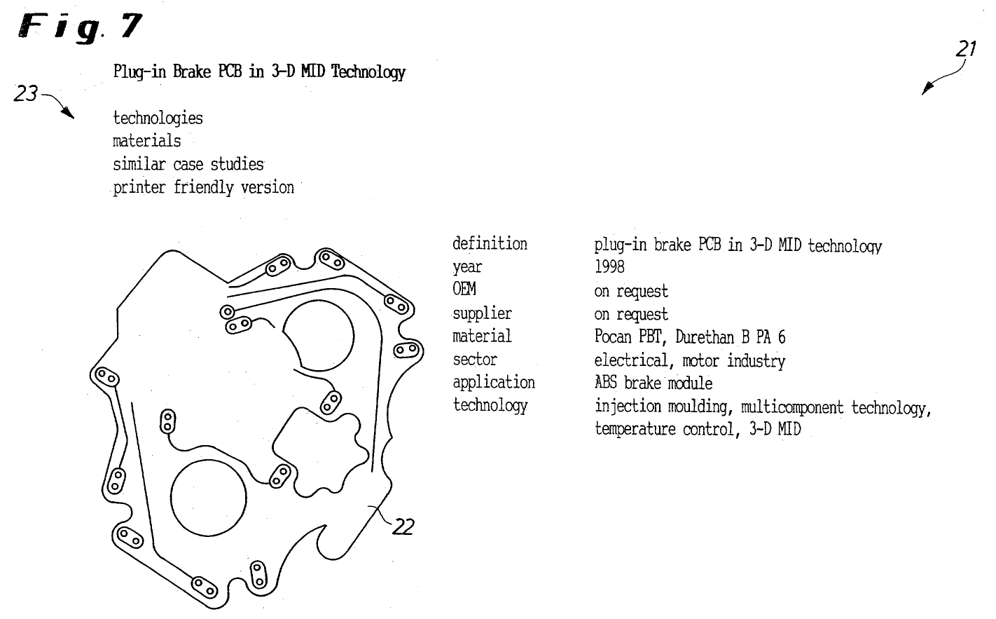

By “clicking” his mouse button on this case study, the user reaches the window 21 of FIG. 7, which contains a display of the case-study file of the “clicked” case study.

In particular, a representation 22 of the plug-in brake PCB, i.e., the product of the selected case study, is displayed in the window 21. Information relating to the definition, the year of development, OEM, supplier, material, sector, application and possible technologies, is contained therein. A detailed description of the case study may also be given in the window 21.

The window 21 also has a selection range 23. By “clicking” on “technologies”, the user obtains further information about this topic. The user can also obtain further information about the possible materials by “clicking” on “materials”.

When the user selects “similar case studies” in the selection range 23, the following happens: the server computer 1 (cf. FIG. 1), i.e., its program 4, accesses the set Mᵢ of the case study Fᵢ displayed in the window 21, and it uses this set Mᵢ as a search query.

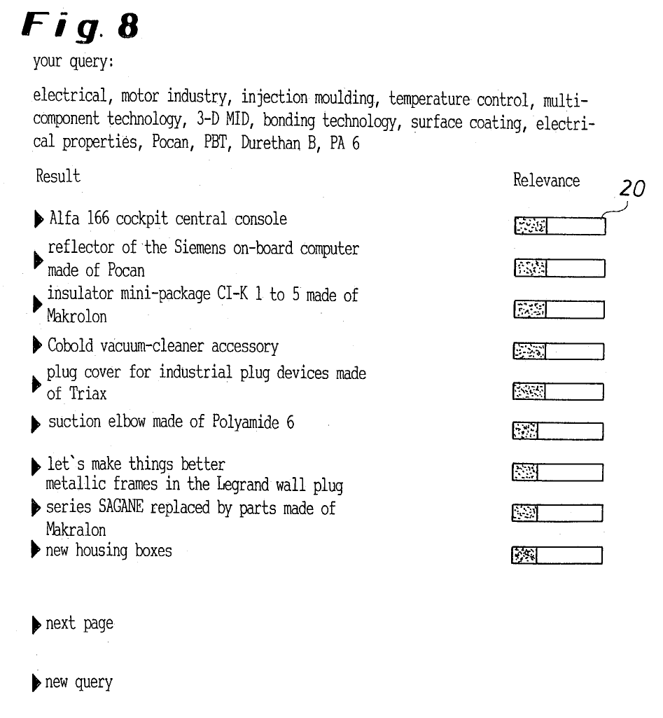

In the example considered in FIG. 7, this set contains the keywords “electrical”, “motor industry”, “injection moulding”, “temperature control”, “multicomponent technology”, “3DMI D”, “bonding technology”, “surface coating”, “electrical properties”, “Pocan”, “PBT”, “Durethan B”, “PA 6”. The result of the search for similar case studies is shown by the list of FIG. 8, the case study “Alfa 166 cockpit central console” having been determined as the most similar case study.

Although described herein for use with polymers and polymer applications, those skilled in the art will recognize that the method of the present invention has applicability to a variety of chemicals and chemical compounds. The inventors contemplate use of the present method for all manner of applications for which comparable data can be organized. The present invention is not intended to be limited solely to polymers and polymer applications.

Although the invention has been described in detail in the foregoing for the purpose of illustration, it is to be understood that such detail is solely for that purpose and that variations can be made therein by those skilled in the art without departing from the spirit and scope of the invention, except as it may be limited by the appended claims.

What is claimed is:

1. A method of searching for and locating a similar case study from a set of case studies (Fᵢ), wherein case study keywords are assigned to each case study, said method comprising:
accepting an input search query containing one or more search keywords (Sⱼ);
determining the most similar case study to each search keyword by
a) calculating the distance from the search keyword to each case study keyword,
b) establishing a minimum (Dⱼ) of the distance,
c) repeating steps a) and b) for each search keyword,
d) summing the minima for each case study,
e) sorting the summed minima by size; and
outputting the case study with the smallest summed minima.

2. The method according to claim 1, wherein the case study keywords and the search keywords belong to the same union set of keywords.

3. The method according to claim 2, wherein the union set of keywords is organized into a tree structure.

4. The method according to claim 3, wherein one of the case study keywords is assigned to each node of the tree structure and a weighting (G) is assigned to each branch in the tree structure, and a distance from the search keyword to the case study keyword is calculated by
determining a shortest path in the tree structure from the search keyword to the case study keyword, and
summing the weightings of the branches of the shortest path.

5. The method according to one of claims 3 and 4, wherein the tree structure comprises a plurality of trees and wherein each tree contains case study keywords of a particular category, such that the case study keywords of the individual trees form disjoint sets.

6. A method of searching for and locating one or more similar case studies from a set of case studies (Fᵢ), wherein case study keywords are assigned to each case study, said method comprising:
accepting an input search query containing one or more search keywords (Sⱼ);
determining the most similar case study to each search keyword by
a) calculating the distance from the search keyword to each case study keyword,
b) establishing a minimum (Dⱼ) of the distance,
c) repeating steps a) and b) for each search keyword,
d) summing the minima for each case study,
e) sorting the summed minima by size; and
outputing the case studies in the form of list sorted by size of summed minima.

7. The method according to claim 6 further including
displaying a case study selected by a user from the sorted list; and
automatically generating a search query with search keywords, which are rigidly assigned to the displayed case study upon user activation of a virtual control element for searching for a case study which is similar to the displayed case study.

8. The method according to one of claims 1 to 4, wherein the search query is input into a server computer from a client computer, the search query from the client computer is processed and the case study is/output by the server computer to the client computer.

9. A computer program comprising the method according to one of claims 1 to 4 and 6.

10. A computer system with means for carrying out the method according to one of claims 1 to 4 and 6.

11. A server computer for searching for and locating a similar case study from a set of case studies (Fᵢ) comprising:
a first database containing case study files and the case study keywords assigned thereto;
a second database containing case study keywords organized into a tree structure;
a means for inputting a search query containing one or more search keywords (Sⱼ);
a means for outputting a case study; and
a computer program containing a set of instructions for determining the most similar case study to the search query comprising,
i. calculating the distances from the search keyword to each case study keyword,
ii. establishing a minimum (Dⱼ) of the distances,
iii. repeating steps i and ii for each search keyword,
iv. summing the minima for each case study,
v. sorting the summed minima by size, and
vi. outputting the case study with the smallest summed minima.

12. A server computer for searching for and locating a similar case study from a set of case studies (Fᵢ) comprising:
a first database containing case study files and the case-study keywords assigned thereto;
a second database containing case study keywords organized into a tree structure;
a means for inputting a search query containing one or more search keywords (Sⱼ);
a means for outputting one or more case studies and a list thereof; and
a computer program containing a set of instructions for determining one or more case studies similar to the search query comprising,
i. calculating the distances from the search keyword to each case study keyword,
ii. establishing a minimum (Dⱼ) of the distances,
iii. repeating steps i and ii for each search keyword,
iv. summing the minima for each case study,
v. sorting the summed minima by size, and
vi. outputting a list of case studies sorted by size of summed minima.

13. The server computer according to one of claims 11 and 12, wherein a case study keyword is assigned to each node of the tree structure and a weighting (G) is assigned to each branch in the tree structure, such that the calculation of the distance from the search keyword to the case study keyword by the program comprises:
determining a shortest path in the tree structure from the search keyword to the case study keyword; and
summing the weightings of the branches of the shortest path.

14. The server computer according to claim 12 further including
a means for displaying a case study selected by a user from the sorted list; and
a means for automatically generating a search query with search keywords which are rigidly assigned to the displayed case study upon user activation of a virtual control element for searching for a case study which is similar to the displayed case study.
